(19) United States
(12) Patent Application Publication
(10) Pub. No.: US 2008/0082787 A1
(43) Pub. Date: Apr. 3, 2008

(54) Delay circuit and processor

(75) Inventor: Masafumi Yamazaki, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/892,210

(22) Filed: Aug. 21, 2007

(30) Foreign Application Priority Data
Sep. 29, 2006 (JP) 2006-269567

(51) Int. Cl. G06F 15/76; G06F 9/02

(52) U.S. Cl. 712/17; 712/E09.002

(57) ABSTRACT

A delay circuit that can prevent an increase in the scale of circuits. A data delay section included in the delay circuit delays input data by a plurality of data delay elements. A validity information delay section included in the delay circuit delays input validity information which indicates that the input data is valid by a plurality of validity information delay elements corresponding to the plurality of data delay elements included in the data delay section. As a result, the input data and the input validity information pass through a data delay element and a validity information delay element, respectively, which are associated with each other at the same timing. An output signal outputted from each data delay element can be taken out. Similarly, an output signal outputted from each validity information delay element can be taken out. Therefore, a plurality of output signals having desired delay amounts can be obtained for one input signal inputted to a delay circuit.

### CROSS-REFERENCE TO RELATED APPLICATIONS

This application is based upon and claims the benefits of priority from the prior Japanese Patent Application No. 2006-269567, filed on Sep. 29, 2006, the entire contents of which are incorporated herein by reference.

### BACKGROUND OF THE INVENTION

(1) Field of the Invention

This invention relates to a delay circuit and a processor and, more particularly, to a delay circuit for delaying and outputting an input signal on the basis of configuration information set in advance and a processor having a delay module including such a delay circuit and an operation processing module for performing predetermined operation processes to perform the predetermined operation processes while switching module connection.

(2) Description of the Related Art

A technique (dynamic reconfigurable technique) for dynamically reconfiguring hardware is conventionally known as a technique for flexibly coping with applications.

For example, a reconfigurable processor which can dynamically be reconfigured includes a configuration memory which stores configuration data, being configuration information regarding the contents of processes performed by a reconfigurable hardware portion and the location (configuration) of the reconfigurable hardware portion, processor elements (PEs) for which the contents of processes can be set, and a network which variably connects the PEs. The configuration of the PEs and the contents of processes are set on the basis of the configuration data stored in the configuration memory and a pipeline process in which an operation process by each PE is performed in parallel is performed. By performing the pipeline process in this way, performance can be improved.

After a series of pipeline processes is performed, the configuration is reconfigured on the basis of the configuration data. However, if the configuration is reconfigured after the series of pipeline processes terminates, switching time becomes an overhead of the entire process. Accordingly, to efficiently perform the switching of configuration at the time of the termination of a pipeline process, a processor for predetermining a clock cycle taken to terminate a process by calculating time taken to perform the configuration and for determining the time when the pipeline process terminates by comparing the number of clocks actually measured with the clock cycle is proposed (see, for example, Japanese Patent Laid-Open publication No. 2006-18413 (FIG. 1)).

With large-scale integrated circuits (LSIs) in which the conventional dynamic reconfigurable technique is used, however, a large number of delay elements must be used for adjusting the timing of operation processes. This leads to an increase in the scale of the circuits.

PEs are roughly divided into arithmetic and logic units (ALUs) for performing an operation process and delay elements for adjusting the timing of processing plural pieces of data. FIG. 13 is a block diagram showing an example of connection of PEs included in a reconfigurable processor.

In this example, the reconfigurable processor performs the operation process of “inputting consecutive input data (a0, a1, a2, a3, etc.), performing the operation ‘(a0+a3)×p0+(a1+a2)×P1,’ and outputting a result”. An ALU 911 performs the operation “a0+a3”. An ALU 912 performs the operation “a1+a2”. An ALU 913 performs the operation “output from the ALU 911 (a0+a3)×p0”. An ALU 914 performs the operation “output from the ALU 912 (a1+a2)×p1”. An ALU 915 performs the operation “output from the ALU 913 [(a0+a3)×p0]+output from the ALU 914 [(a1+a2)×p1]”.

For example, the ALU 911 adds together a0 and a3 inputted three cycles after a0. To adjust the timing of the operation process, three delay elements 921, 922, and 923 are connected to a signal transmission path. a0 is inputted to the ALU 911 via the delay elements 921, 922, and 923. As a result, input of a0 to the ALU 911 is delayed by three cycles and a0 and a3 can be inputted at the same timing. Each of the delay elements 921, 922, and 923 delays input data by one cycle and outputs the input data.

Similarly, to adjust the timing at which a1 and a2 are inputted and the timing at which the ALUs 911 and 912 perform the operation processes, a1 is inputted to the ALU 912 via the two delay elements 921 and 922 and a2 is inputted to the ALU 912 via the one delay element 921. As a result, a1 and a2 can be inputted to the ALU 912 at the same timing. Moreover, the ALUs 911 and 912 begin to perform the operation processes at the same timing.

In this example, the ALUs 911 and 912 perform the operation processes at the same timing. Therefore, it is possible to output the operation results without connecting new delay elements to the ALUs 913 and 914 at the next stage. However, it is necessary to connect additional delay elements, depending on operation processes. Furthermore, in the above descriptions the four pieces of data are inputted. However, if eight pieces of data are used for performing the same process, then seven delay elements are needed. Accordingly, to realize a configuration having a high degree of freedom, various cases must be supposed. As a result, many delay elements must be prepared.

As stated above, if an LSI in which the dynamic reconfigurable technique is used is designed, a large number of delay elements must be prepared. This leads to an increase in the scale of the circuit.

In addition, an ALU generally begins an operation by receiving data to which a validity flag indicative that the data is valid is added, and outputs a result to which a validity flag is added. With the ALU 911 shown in FIG. 13, for example, the pieces of input data with validity flags are inputted in order. As a result, the operation process of adding together current input data and input data inputted three cycles ago is performed every time and an operation result is outputted. An operation result may not be needed at the next stage for some combinations created at this time. In this case, a management process must be performed to discard unnecessary data.

### SUMMARY OF THE INVENTION

The present invention was made under the background circumstances described above. An object of the present invention is to provide a delay circuit and a processor that can prevent an increase in the scale of circuits without lowering the degree of freedom of a configuration.

In order to achieve the above object, a delay circuit for delaying and outputting an input signal on the basis of configuration information set in advance is provided. This delay circuit comprises a data delay section including a plurality of data delay elements for delaying output of input data on the basis of predetermined delay amounts individually set at the time of receiving the input data and a validity information delay section including a plurality of validity information delay elements for delaying output of validity information appended to the input data in the case of the input data being valid according to the corresponding input data at the time of receiving the validity information.

In addition, in order to achieve the above object, a processor for performing predetermined operation processes while switching connection of modules for delaying an input signal and performing the predetermined operation processes on the basis of configuration information set in advance is provided. This processor comprises a delay module including a data delay section including a plurality of data delay elements for delaying output of input data on the basis of predetermined delay amounts individually set at the time of receiving the input data and a validity information delay section including a plurality of validity information delay elements for delaying output of validity information appended to the input data in the case of the input data being valid according to the corresponding input data at the time of receiving the validity information and an operation processing module for inputting output data and the validity information outputted from the delay module and for performing the predetermined operation processes on the basis of the configuration information.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the concept of the present invention applied to embodiments.

FIG. 2 is a block diagram showing an example of the structure of a reconfigurable processor according to an embodiment of the present invention.

FIG. 3 is a block diagram showing an example of the structure of a data delay section included in a multi-output delay element according to an embodiment of the present invention.

FIG. 4 is a block diagram showing another example of the structure of a data delay section included in the multi-output delay element according to the embodiment of the present invention.

FIG. 5 is a view showing an example of PE connection using the multi-output delay element according to the embodiment of the present invention.

FIG. 6 is a circuit block diagram showing an example of the circuit structure of the data delay section included in the multi-output delay element according to the embodiment of the present invention.

FIG. 7 is a circuit block diagram showing an example of the circuit structure of a validity information delay section included in the multi-output delay element according to the embodiment of the present invention.

FIG. 8 is a circuit block diagram showing an example of the circuit structure of a delay control section included in the multi-output delay element according to the embodiment of the present invention.

FIG. 9 is a view showing a multi-output delay element according to an embodiment of the present invention used in examples.

FIG. 10 is a time chart showing the operation of the multi-output delay element according to the embodiment of the present invention used in example 1.

FIG. 11 is a time chart showing the operation of the multi-output delay element according to the embodiment of the present invention used in example 2.

FIG. 12 is a time chart showing the operation of the multi-output delay element according to the embodiment of the present invention used in example 3.

FIG. 13 is a block diagram showing an example of connection of PEs included in a reconfigurable processor.

### DESCRIPTION OF THE PREFERRED EMBODIMENTS

Embodiments of the present invention will now be described with reference to the drawings. The concept of the present invention applied to embodiments will be described first and the concrete contents of the embodiments will then be described.

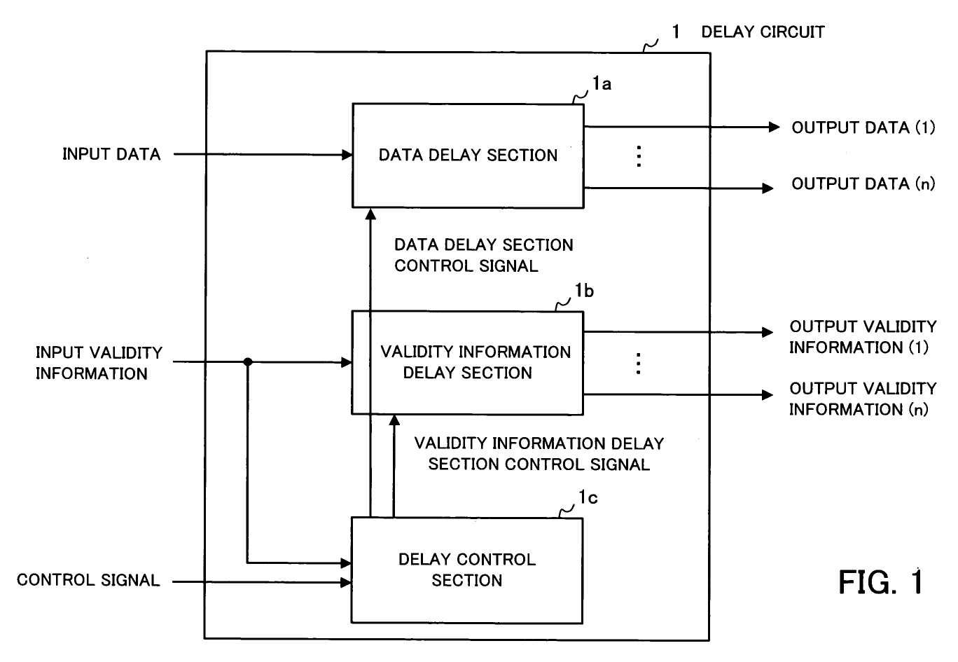

FIG. 1 is a view for describing the concept of the present invention applied to embodiments.

A delay circuit 1 according to the present invention comprises a data delay section 1a, a validity information delay section 1b, and a delay control section 1c. If the delay circuit 1 is incorporated into an LSI, the whole of the delay circuit 1 is incorporated as one delay module. The delay circuit 1 receives input data and validity information appended thereto in the case of the input data being valid.

The data delay section 1a includes a plurality of data delay elements for delaying output of the input data on the basis of predetermined delay amounts individually set. The data delay section 1a is connected to a signal line by which it accepts the input data and is connected to a plurality of signal lines by which it outputs output data generated to the outside. When each data delay element receives the input data from the outside via the signal line, it delays output of the input data by a delay amount set therefor. As a result, plural pieces of output data (1), . . . , and output data (n) the delay amounts of which differ from one another are generated from the same input data. The n is an arbitrary integer. The plural pieces of output data (1), . . . , and output data (n) are outputted to the outside via the predetermined signal lines.

The validity information delay section 1b includes a plurality of validity information delay elements for delaying output of the input validity information on the basis of predetermined delay amounts corresponding to the plurality of data delay elements included in the data delay section 1a. The validity information delay section 1b is connected to a signal line by which it accepts the input validity information and is connected to a plurality of signal lines by which it outputs output validity information generated to the outside. The validity information delay section 1b accepts the validity information appended to the input data inputted to the data delay section 1a in the case of the input data being valid and delays output of the validity information according to corresponding delays of the input data created by the data delay section 1a. As a result, the input validity information appended to the input data is outputted as output validity information (1), . . . , and output validity information (n) to timing at which the data delay section 1a outputs the corresponding output data (1), . . . , and output data (n).

The delay control section 1c is connected to signal lines by which a control signal and the input validity information are inputted and is connected to signal lines by which control signals for controlling the data delay section 1a and the validity information delay section 1b are sent. When the delay control section 1c receives a control signal for designating the operation of the delay circuit 1 and the input validity information, the delay control section 1c controls the operation of the data delay section 1a and the validity information delay section 1b on the basis of the control signal and the input validity information. In this example, the delay control section 1c outputs a data delay section control signal to the data delay section 1a and outputs a validity information delay section control signal to the validity information delay section 1b. By doing so, the delay control section 1c controls the data delay section 1a and the validity information delay section 1b.

If the control signal is a signal for giving instructions to stop the operation of the delay circuit 1, then the delay control section 1c sets the data delay section control signal and the validity information delay section control signal according to the control signal and stops the operation of the data delay section 1a and the validity information delay section 1b. While stop requests are being outputted by these control signals, the data delay section 1a and the validity information delay section 1b stop their operation.

If the control signal is a signal for designating the operation of the delay circuit 1 on the basis of configuration information set in advance, then the delay control section 1c controls the operation, such as output of validity information, of the data delay section 1a and the validity information delay section 1b in accordance with the designation. For example, the delay control section 1c monitors input validity information appended to input data. If input validity information is not appended, then the delay control section 1c controls the data delay section 1a so that the data delay section 1a will not perform delay processing operation. In addition, the delay control section 1c may include a counter. In this case, for example, the delay control section 1c counts the number of pieces of input data to which input validity information is appended, controls the validity information delay section 1b according to a count value, and handles the states of the output validity information (1), . . . , and the output validity information (n) outputted from the validity information delay section 1b. The details will be described later.

The operation of the delay circuit 1 having the above structure will be described.

When the delay circuit 1 receives input data and input validity information indicative that the input data is valid, the delay circuit 1 sends the input data to the data delay section 1a and sends the input validity information to the validity information delay section 1b. The data delay section 1a includes the data delay element group for setting the predetermined delay amounts. The validity information delay section 1b includes the validity information delay element group for setting the predetermined delay amounts. The data delay element group are associated with the validity information delay element group. Unless otherwise designated, a combination of the input data and the input validity information is outputted from the data delay section 1a and the validity information delay section 1b at the same timing. Signal lines for outputting output data to the outside are connected to two or more data delay elements of the data delay element group included in the data delay section 1a. Moreover, signal lines for outputting output validity information to the outside are connected to two or more validity information delay elements of the validity information delay element group included in the validity information delay section 1b. As a result, one combination of the input data and the input validity information is outputted as plural combinations of output data and output validity information the delay amounts of which differ from one another.

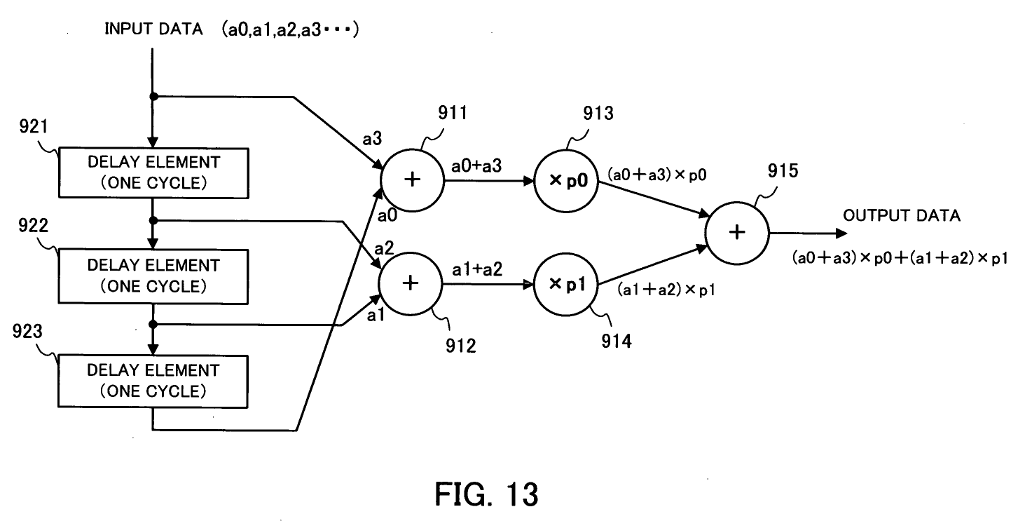

For example, it is assumed that a0 and a3 inputted three cycles after a0 are selected from among the consecutive input data (a0, a1, a2, a3, . . . ) shown in FIG. 13 and that a0 and a3 are added together (a0+a3) by an operational circuit at the subsequent stage. It is assumed that the data delay section 1a in the delay circuit 1 includes the plurality of data delay elements for delaying the input data by one cycle. Out of plural pieces of output data (1), . . . , output data (n) outputted from the delay circuit 1, the operational circuit at the subsequent stage selects and connects two pieces of output data the delay amounts of which differ by three cycles. By doing so, operation timing can be adjusted by the one delay circuit 1. This is the same with input validity information.

As stated above, in the present invention plural pieces of output data the delay amounts of which differ from one another and plural pieces of output validity information the delay amounts of which differ from one another can be obtained from the same piece of input data. Therefore, the number of delay circuits which have been located according to piece of output data can be reduced.

Furthermore, the delay control section 1c controls the data delay section 1a and the validity information delay section 1b by control signals generated on the basis of configuration information. By doing so, adjustment of operation timing can be controlled more finely.

Embodiment of the present invention will now be described in detail with reference to the drawings with the case where the present invention is applied to a reconfigurable processor as an example.

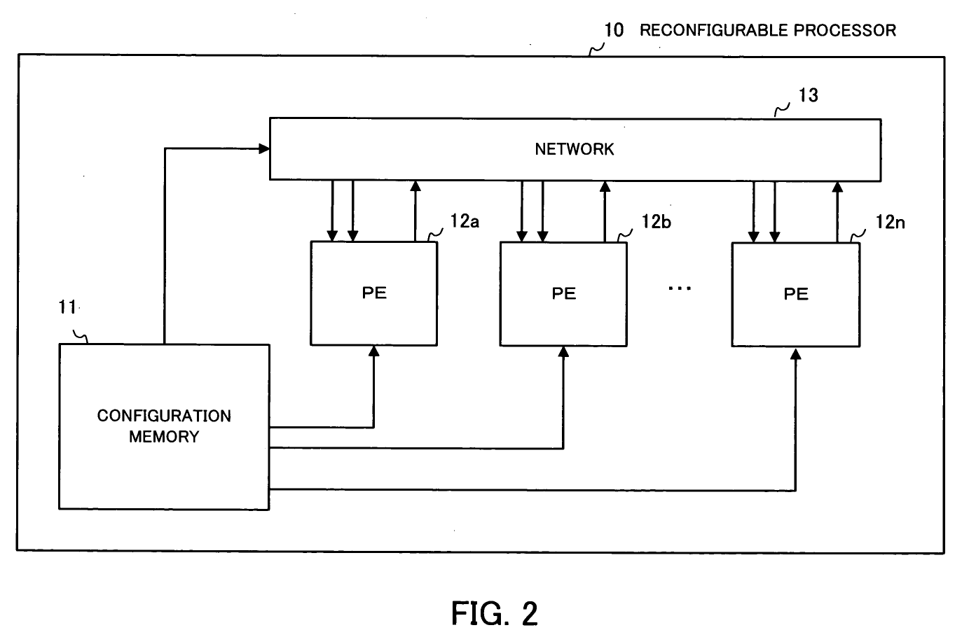

FIG. 2 is a block diagram showing an example of the structure of a reconfigurable processor according to an embodiment of the present invention.

A reconfigurable processor 10 according to an embodiment of the present invention comprises a configuration memory 11, PEs 12a, 12b, . . . , and 12n, and a network 13.

The configuration memory 11 stores configuration data which is configuration information regarding the contents of processes performed by the PEs 12a, 12b, and 12n, the location of the PEs 12a, 12b, . . . , and 12n, PE connection on the network 13, and the like.

The PEs 12a, 12b, . . . , and 12n make up an element group. Each of the PEs 12a, 12b, . . . , and 12n is an ALU for performing a process, such as addition, subtraction, multiplication, division, or a logic operation, or a delay element which functions as a delay module. Each of the PEs 12a, 12b, . . . , and 12n performs a process in accordance with operation settings stored in the configuration memory 11. A multi-output delay element according to the present invention for delaying a piece of input data with validity information by different delay amounts and for outputting plural pieces of output data with validity information the delay amounts of which differ from one another is also included in the element group.

The network 13 transfers data between the PEs 12a, 12b, . . . , and 12n. A data flow between the PEs 12a, 12b, and 12n via the network 13 is switched in accordance with connection settings stored in the configuration memory 11.

For example, it is assumed that the PE 12a is set as a multi-output delay element in the configuration data stored in the configuration memory 11 and that the PE 12b is set as an ALU for adding together two pieces of output data outputted from the PE 12a in the configuration data stored in the configuration memory 11. The PE 12a outputs input data inputted via the network 13 as plural pieces of output data the delay amounts of which differ from one another in accordance with the configuration data. The network 13 transfers predetermined pieces of output data outputted from the PE 12a to the PE 12b which is an adding element in accordance with the configuration data. The PE12b adds together the pieces of input data and outputs a result to the network 13. The network 13 transfers the data to the next PE connected.

A multi-output delay element according to an embodiment of the present invention will be described.

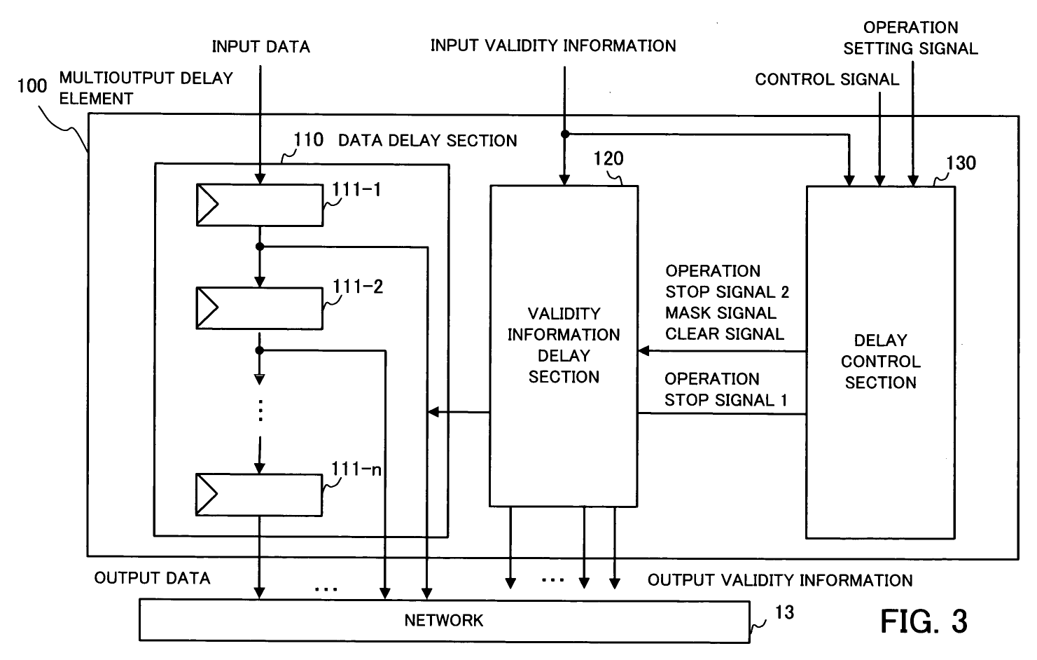

FIG. 3 is a block diagram showing an example of the structure of a data delay section included in a multi-output delay element according to an embodiment of the present invention.

A multi-output delay element 100 comprises a data delay section 110, a validity information delay section 120, and a delay control section 130.

The data delay section 110 includes data delay elements 111-1, 111-2, . . . , 111-n that form a data delay element train on a path along which input data is transmitted. The data delay elements 111-1, 111-2, . . . , 111-n delay the input data by predetermined delay amounts and output the output data the delay amounts of which are predetermined to the outside. In this example, the data delay element 111-1 delays the input data inputted from the outside and outputs it to the data delay element 111-2 at the subsequent stage. The input data is transferred in order between data delay elements in the same way and flows to the data delay element 111-n at the final stage. Output of each data delay element is outputted to a network 13 by a signal line connected to each output terminal. By adopting the above structure, plural pieces of output data the delay amounts of which differ from one another are generated for a piece of input data.

For example, it is assumed that each of the data delay elements 111-1, 111-2, . . . , 111-n delays the input data by one cycle and that each of the data delay elements 111-1, 111-2, . . . , 111-n outputs the input data. The delay amounts of the data outputted from the data delay elements 111-1 and 111-n are one cycle and n cycles respectively. As a result, data having an arbitrary delay amount by the cycle can be obtained. By selecting a data delay element which delays input data by a required delay amount, a user can obtain desired delayed data.

The data delay section 110 accepts an operation stop signal 1 sent from the delay control section 130. If a stop is designated by the operation stop signal 1, then the data delay section 110 stops a delay process.

The validity information delay section 120 delays input validity information appended to the input data according to the delay amount of output data outputted from the data delay section 110 and outputs the validity information to timing at which the corresponding output data is outputted. For example, the validity information delay section 120 includes validity information delay elements that form a train on a path along which the input validity information is transmitted. This is the same with the data delay section 110. The validity information delay section 120 accepts an operation stop signal 2 sent from the delay control section 130. If a stop is designated by the operation stop signal 2, then the validity information delay section 120 stops a delay process. The validity information delay section 120 also accepts a mask signal and a clear signal by which the value of output validity information is controlled from the delay control section 130 and handles the output validity information in response to these control signals.

The delay control section 130 accepts a control signal, an operation setting signal, and the input validity information, handles the operation stop signals 1 and 2, the mask signal, and the clear signal in response to these signals, and controls the data delay section 110 and the validity information delay section 120.

The control signal inputted to the delay control section 130 is a signal for giving instructions to stop the operation of the multi-output delay element 100. The operation setting signal inputted to the delay control section 130 is indication information for designating operation on the basis of configuration data. The operation stop signal 1 outputted from the delay control section 130 is a signal for stopping a delay process performed by the data delay section 110. The operation stop signal 2 outputted from the delay control section 130 is a signal for stopping a delay process performed by the validity information delay section 120. The mask signal outputted from the delay control section 130 is a control signal for keeping the value of the output validity information outputted from the validity information delay section 120 in an invalid state for an arbitrary period. The clear signal outputted from the delay control section 130 is a control signal for resetting the value of validity information held by each validity information delay element included in the validity information delay section 120. To cope with various cases, the delay control section 130 controls the data delay section 110 and the validity information delay section 120 by using these signals. Therefore, a user can exercise delay control which has traditionally been performed by connecting many PEs only by the multi-output delay element 100. Examples will be described later.

In the above descriptions the output data outputted from the data delay elements 111-1, 111-2, . . . , 111-n included in the data delay section 110 is directly sent to the network 13. In that case, however, there is variation in loads that occur at the time of outputting the output data to the network 13. As a result, a problem arises in the case of high-speed operation. An example of the structure of a data delay section used for high-speed operation will now be described.

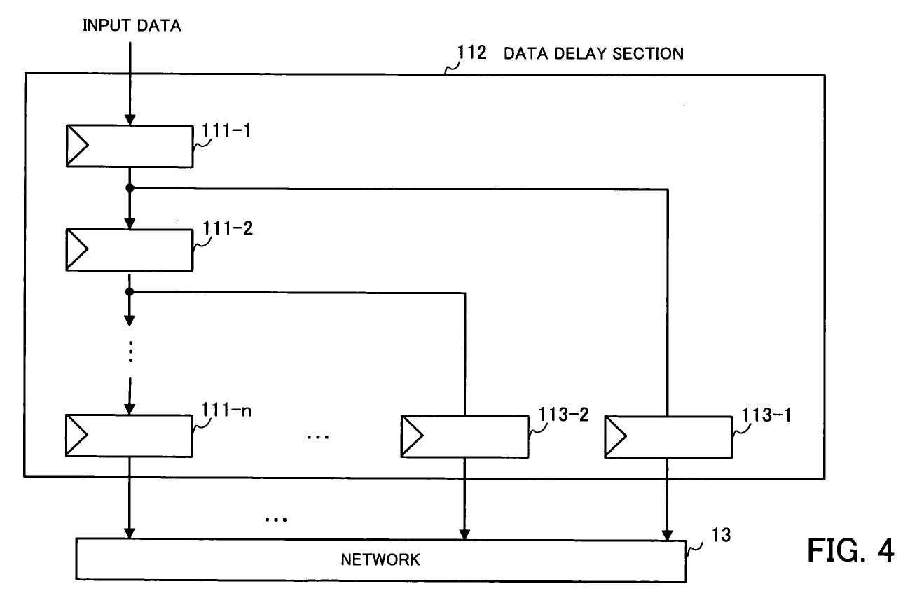

FIG. 4 is a block diagram showing another example of the structure of a data delay section included in the multi-output delay element according to the embodiment of the present invention. Components in FIG. 4 that are the same as those shown in FIG. 3 are marked with the same numbers and descriptions of them will be omitted.

A data delay section 112 can be substituted for the data delay section 110 included in the multi-output delay element 100 shown in FIG. 3. The data delay section 112 includes output dedicated registers 113-1, 113-2, etc. on signal lines which connect data delay elements 111-1, 111-2, . . . , 111-n and a network 13. Loads that occur at the time of outputting output data to the network 13 can be equalized by using the output dedicated registers 113-1, 113-2, etc. As a result, operation can be stabilized at high-speed operation time.

The operation of the multi-output delay element according to the embodiment of the present invention will now be described by using an example of PE connection.

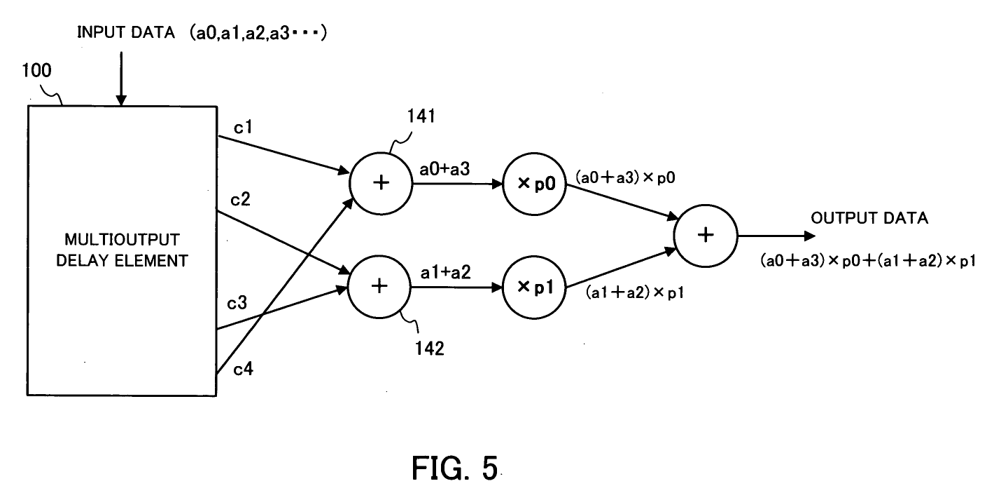

FIG. 5 is a view showing an example of PE connection using the multi-output delay element according to the embodiment of the present invention. In this example, the conventional operation process shown in FIG. 13 is performed by using the multi-output delay element according to the embodiment of the present invention.

As shown in FIG. 3, the multi-output delay element 100 includes the data delay elements 111-1, 111-2, . . . , 111-n that form a data delay element train. The data delay elements 111-1, 111-2, . . . , 111-n delay input data by one cycle and output this data. In the data delay element train, it is assumed that output data obtained by delaying input data by one cycle is c1, that output data obtained by delaying input data by two cycles is c2, that output data obtained by delaying input data by three cycles is c3, and that output data obtained by delaying input data by four cycles is c4.

An adding element 141 accepts c1 and c4 inputted three cycles before c1 and performs an adding process. By doing so, the adding element 141 performs the process of adding together a0 and a3 inputted three cycles after a0 (“a0+a3”). An adding element 142 performs the process of adding together c3 and c2 outputted at the same timing as c4 and c1 (this process corresponds to “a1+a2”). The subsequent operation process is the same as that shown in FIG. 13, so descriptions of it will be omitted.

As stated above, the operation process which has traditionally been performed by using three delay elements can be performed by using one multi-output delay element. As a result, the number of delay circuits which have been located according to output signal can be reduced.

For example, to process consecutive input data, predetermined time is required for collecting data used for performing an operation. Therefore, adjustment of operation timing by delay elements is indispensable. The multi-output delay element according to the embodiment of the present invention is effective especially in such a case. In the above example, the four inputs are used. However, the effect of a reduction in the number of delay elements heightens with an increase in the number of inputs.

An example of the circuit structure of each of the data delay section, the validity information delay section, and the delay control section included in the multi-output delay element will now be described.

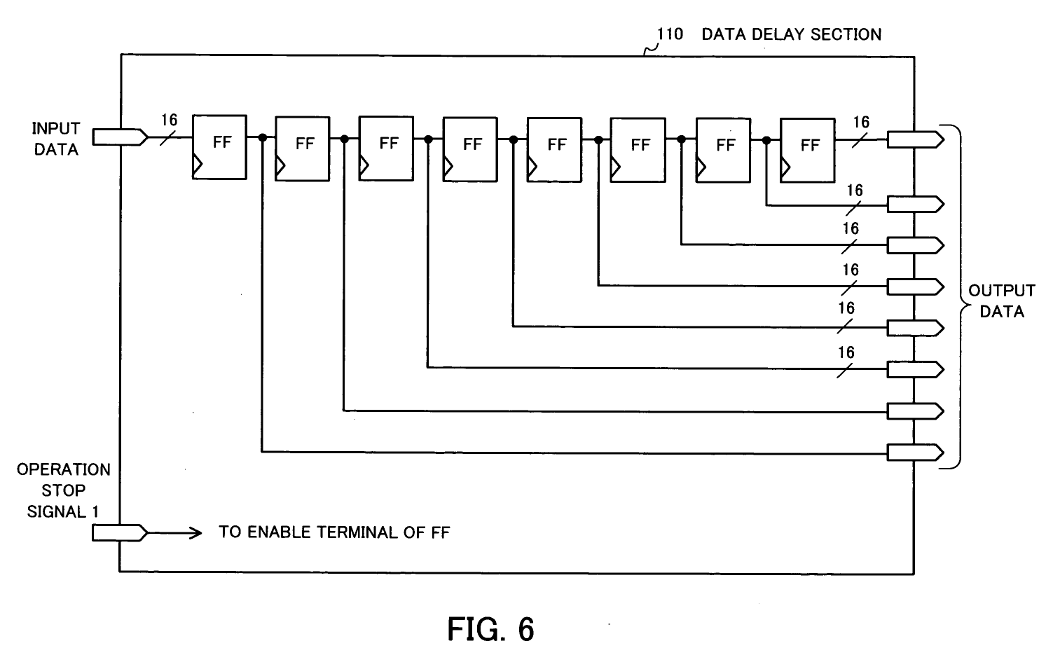

FIG. 6 is a circuit block diagram showing an example of the circuit structure of the data delay section included in the multi-output delay element according to the embodiment of the present invention. In this example, one input is provided and eight outputs are obtained.

In the data delay section 110 included in the multi-output delay element according to the embodiment of the present invention, eight flip-flops (FFs) are located in series on a path along which input data is transmitted as delay elements.

In response to a clock signal, each FF delays the input data by one cycle and outputs the input data. The operation stop signal 1 is inputted to an enable terminal of each FF and the operation of each FF can be stopped by the operation stop signal 1.

Each time the input data passes through an FF, the input data is delayed by one cycle. That is to say, the input data is delayed by one through eight cycles. As a result, the input data the delay amounts of which are one through eight cycles is outputted to eight output terminals connected to the eight FFs as output data. If the operation stop signal 1 is inputted, each FF stops its operation and keeps the state.

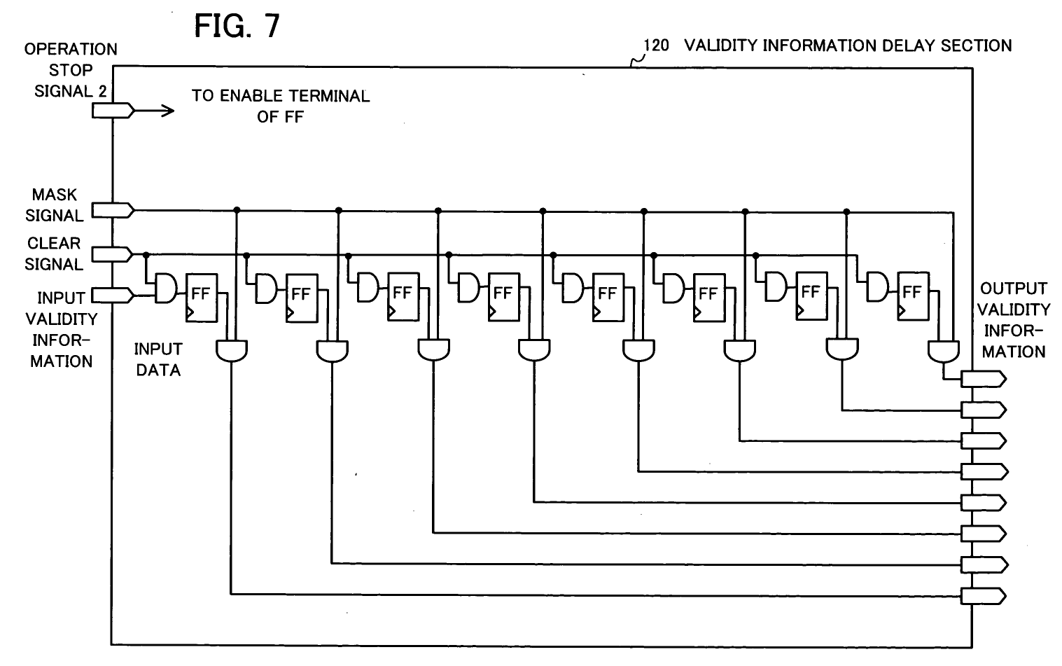

FIG. 7 is a circuit block diagram showing an example of the circuit structure of the validity information delay section included in the multi-output delay element according to the embodiment of the present invention. In this example, one input is provided and eight outputs are obtained.

In the validity information delay section 120 included in the multi-output delay element according to the embodiment of the present invention, eight FFs are located in series on a path along which input validity information is transmitted as delay elements.

An input terminal and an output terminal of each FF are connected to AND elements. The logical product of output from an FF located in front of each FF and the clear signal is inputted by an AND element located on the input side. The logical product of output from each FF and the mask signal is outputted from the validity information delay section 120 by an AND element located on the output side as output validity information.

It is assumed that if validity information is “1,” then an ALU at a subsequent stage determines that input data is valid data to which validity information is appended. Furthermore, it is assumed that if validity information is “0,” then the ALU at the subsequent stage determines that input data is invalid data to which validity information is not appended. In response to a clock signal, each FF delays the input validity information by one cycle and outputs the input validity information. At this time each FF holds the validity information (which is referred to as internal validity information). When the clear signal goes into the low state, the internal validity information is reset to “0” (no validity information). When the mask signal goes into the low state, output validity information outputted to an output terminal becomes “0” (no validity information) regardless of output validity information outputted from each FF.

If the mask signal and the clear signal are in the high state, then the input validity information is delayed by one cycle each time the input validity information passes through an FF. That is to say, the input validity information is delayed by one through eight cycles. As a result, the input validity information the delay amounts of which are one through eight cycles is outputted to eight output terminals connected to the eight FFs as output data. If the operation stop signal 2 is inputted, each FF stops its operation and keeps the state. When the mask signal goes into the low state, all pieces of output validity information outputted from the validity information delay section 120 become “0” (no validity information). Therefore, all corresponding pieces of input data become input data to which validity information is not appended, and are treated as invalid data by the ALU at the subsequent stage. When the clear signal goes into the low state, all pieces of internal validity information are reset to “0” and all of the pieces of output validity information outputted from the validity information delay section 120 are reset to “0” accordingly.

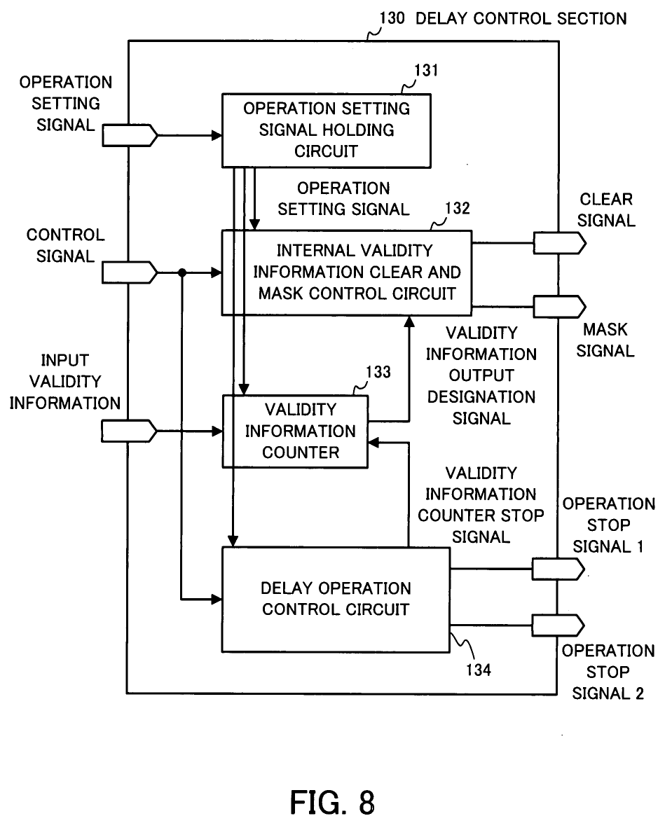

FIG. 8 is a circuit block diagram showing an example of the circuit structure of the delay control section included in the multi-output delay element according to the embodiment of the present invention.

The delay control section 130 included in the multi-output delay element according to the embodiment of the present invention includes an operation setting signal holding circuit 131, an internal validity information clear and mask control circuit 132, a validity information counter 133, and a delay operation control circuit 134.

When the operation setting signal holding circuit 131 receives the operation setting signal, the operation setting signal holding circuit 131 holds the operation setting signal and controls the internal validity information clear and mask control circuit 132, the validity information counter 133, and the delay operation control circuit 134 in response to the operation setting signal.

The internal validity information clear and mask control circuit 132 sets the clear signal and the mask signal in response to the control signal and the operation setting signal held by the operation setting signal holding circuit 131 and handles the output validity information outputted from the validity information delay section 120. For example, if the operation is stopped by the control signal, the internal validity information clear and mask control circuit 132 handles the clear signal in response to a request by the operation setting signal, clears the internal validity information held by the FFs included in the validity information delay section 120, and initializes the state of the validity information delay section 120. In the case of preventing the ALU at the subsequent stage from performing an operation process, the internal validity information clear and mask control circuit 132 handles the mask signal to forcedly reset the output validity information to be outputted from the validity information delay section 120 (to no validity information). Timing at which the mask signal or the clear signal is handled can be determined according to the number of pieces of input data to which validity information is appended. For example, the internal validity information clear and mask control circuit 132 may handle the mask signal so that only if a validity information output designation signal outputted from the validity information counter 133 goes into the on state, the FFs included in the validity information delay section 120 are made to output validity information.

The validity information counter 133 counts the number of times valid input data to which validity information is appended is inputted. The validity information counter 133 compares the count with a number set in advance. If they match, then the validity information counter 133 outputs the validity information output designation signal to the internal validity information clear and mask control circuit 132. If a validity information counter stop signal is inputted, then the validity information counter 133 stops its operation. The process can be changed in this way according to the number of times input data to which validity information is appended is inputted.

The delay operation control circuit 134 outputs the validity information counter stop signal and the operation stop signals 1 and 2 in response to the control signal and the operation setting signal to control the operation of the validity information counter 133, the data delay section 110, and the validity information delay section 120 respectively.

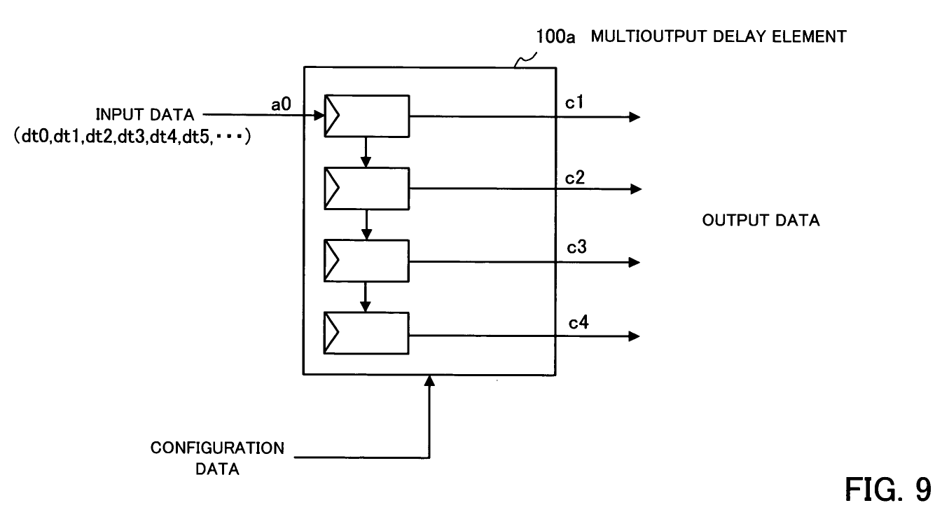

The operation of a multi-output delay element according to an embodiment of the present invention will now be described by giving several examples. FIG. 9 is a view showing a multi-output delay element according to an embodiment of the present invention used in examples.

A multi-output delay element 100a used in the following examples performs a delay process on the basis of configuration data. Consecutive input data dt0, dt1, dt2, dt3, dt4, dt5, etc. is inputted from an input terminal (a0). The multi-output delay element 100a includes four data delay elements each of which delays the input data by one cycle. Output data of the data delay elements is outputted from output terminals c1, c2, c3, and c4.

### (1) Example 1

In example 1, an operation process is performed by using a combination of three consecutive pieces of input data.

In this example, when three pieces of input data inputted from the input terminal (a0) are collected, an operation is performed. That is to say, when dt0, dt1, and dt2 are inputted, the operation “dt0+dt1+dt2” is performed. The operation “dt3+dt4+dt5” is then performed when dt3, dt4, and dt5 are inputted. With the multi-output delay element according to the embodiment of the present invention, a validity information counter 133 counts the number of pieces of input data which are inputted and to each of which validity information is appended, and detects whether three pieces of input data are collected. A mask signal is handled according to a detection result so that only when three pieces of input data are collected, an operation will be performed. Accordingly, instructions to put a validity information output designation signal into the on state when the number of pieces of input data to which validity information is appended reaches a designated number (three, in this example) and to reset the count are given to the validity information counter 133 on the basis of an operation setting signal. Instructions to permit output of validity information corresponding to output data by putting a mask signal and a clear signal into the low and high states, respectively, for one cycle after the validity information output designation signal goes into the on state are given to an internal validity information clear and mask control circuit 132 on the basis of the operation setting signal.

The operation of the multi-output delay element to which the above settings are given will be described by using a time chart.

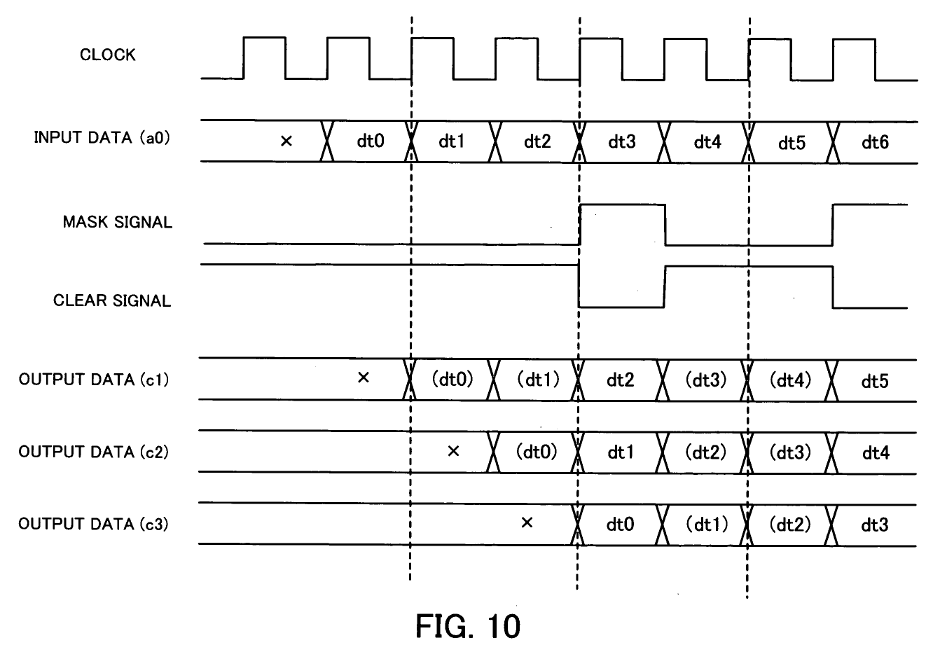

FIG. 10 is a time chart showing the operation of the multi-output delay element according to the embodiment of the present invention used in example 1. Invalid data to which validity information is not appended is shown by “( )”.

The consecutive input data dt0, dt1, dt2, dt3, dt4, dt5, etc. inputted to the input terminal a0 of the multi-output delay element are delayed by each data delay element by one cycle and are outputted from the output terminals c1, c2, and c3.

The validity information counter 133 counts the number of pieces of input data to which validity information is appended. When dt0 and dt1 are inputted, the count does not reach the designated number (three). Accordingly, the validity information output designation signal is in the off state. At this time the mask signal and the clear signal outputted from the internal validity information clear and mask control circuit 132 are in the high and low states respectively. As a result, validity information is not appended to dt1 and dt0 outputted from the output terminals c1 and c2, respectively, and an ALU at a subsequent stage does not perform an operation process.

When d2 is inputted and the count of the validity information counter 133 reaches the designated number (three, in this example), the validity information output designation signal goes into the on state. The validity information counter 133 also resets the count. The internal validity information clear and mask control circuit 132 puts the mask signal and the clear signal into the low and high states, respectively, for one cycle after the internal validity information clear and mask control circuit 132 detects that the validity information output designation signal has gone into the on state. Therefore, when dt2, dt1, and dt0 are outputted from the output terminals c1, c2, and c3 respectively, validity information appended to these pieces of data becomes valid. dt0, dt1, and dt2 to which the validity information is appended are inputted, so the ALU at the subsequent stage performs an operation process.

When the next dt4 is inputted, the count of the validity information counter 133 has been reset. As a result, the mask signal and the clear signal go into the high and low states respectively. Accordingly, validity information is not appended to data outputted from the output terminals c1, c2, and c3, and the ALU at the subsequent stage does not perform an operation process.

When dt5 is inputted, the count of the validity information counter 133 reaches the designated number (three) again. As a result, validity information appended to dt3, dt4, and dt5 is valid and an operation is performed.

Validity information appended to output data is handled in this way. As a result, validity information appended to output data can be made valid only when data used for performing an operation is collected. By doing so, an unnecessary operation can be avoided at the subsequent stage and there is no need to discard an unnecessary operation result.

### (2) Example 2

In example 2, when consecutive input data is collected, operation processes are performed in order by using the consecutive input data.

In this example, each time four pieces of data are inputted from the input terminal (a0), an operation process is performed. That is to say, when dt0, dt1, dt2, and dt3 are inputted, the operation “dt0+dt1+dt2+dt3” is performed. When dt4 is then inputted, the operation “dt1+dt2+dt3+dt4” is performed. With the multi-output delay element according to the embodiment of the present invention, the validity information counter 133 counts the number of pieces of input data which are inputted and to each of which validity information is appended, and detects whether four pieces of input data are collected. The mask signal is handled according to a detection result so that only when and after four pieces of input data are collected, an operation will be permitted. Accordingly, instructions to put the validity information output designation signal into the on state when and after the number of pieces of input data to which validity information is appended reaches the designated number (four, in this example) are given to the validity information counter 133 on the basis of the operation setting signal. Instructions to permit output of validity information corresponding to output data by putting the mask signal and the clear signal into the low and high states, respectively, for one cycle while the validity information output designation signal is in the on state are given to the internal validity information clear and mask control circuit 132 on the basis of the operation setting signal. The internal validity information clear and mask control circuit 132 may hold the states of the mask signal and the clear signal.

The operation of the multi-output delay element to which the above settings are given will be described by using a time chart.

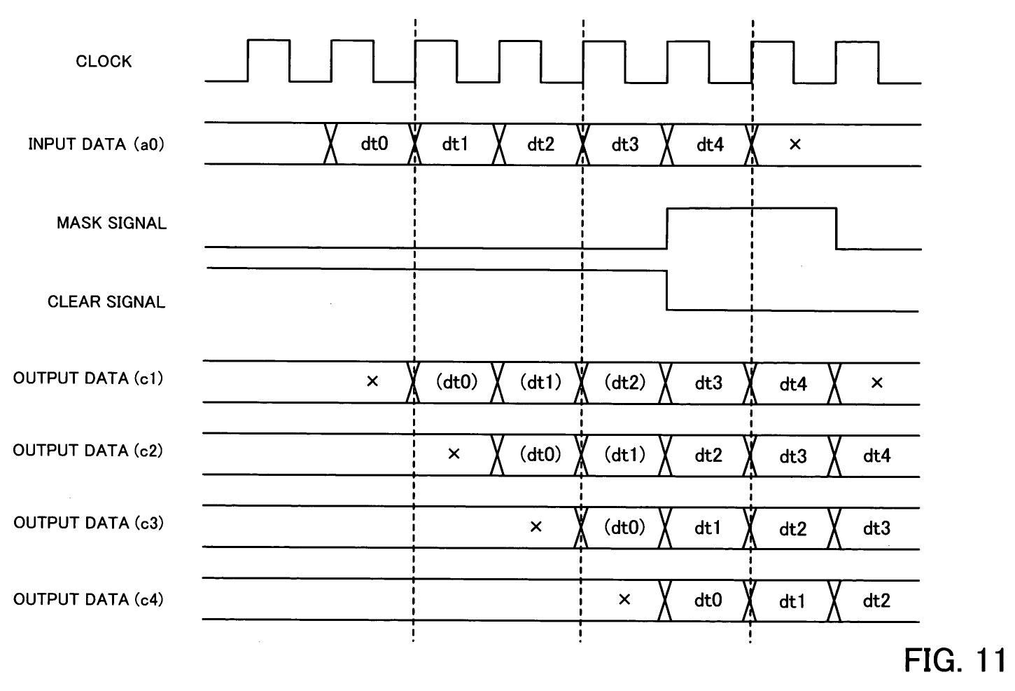

FIG. 11 is a time chart showing the operation of the multi-output delay element according to the embodiment of the present invention used in example 2.

The consecutive input data dt0, dt1, dt2, dt3, dt4, dt5, etc. inputted to the input terminal a0 of the multi-output delay element are delayed by each data delay element by one cycle and are outputted from the output terminals c1, c2, c3, and c4.

The validity information counter 133 counts the number of pieces of input data to which validity information is appended. When dt0, dt1, and dt2 are inputted, the count does not reach the designated number (four). Accordingly, the validity information output designation signal is in the off state. At this time the mask signal and the clear signal outputted from the internal validity information clear and mask control circuit 132 are in the high and low states respectively. As a result, validity information is not appended to dt2, dt1, and dt0 outputted from the output terminals c1, c2, and c3, respectively, and the ALU at the subsequent stage does not perform an operation process.

When d4 is inputted and the count of the validity information counter 133 reaches the designated number (four, in this example), the validity information output designation signal goes into the on state. The internal validity information clear and mask control circuit 132 puts the mask signal and the clear signal into the low and high states, respectively. Therefore, when dt3, dt2, dt1, and dt0 are outputted from the output terminals c1, c2, c3, and c4 respectively, validity information appended to these pieces of data becomes valid. As a result, the ALU at the subsequent stage performs an operation process.

In the next cycle the validity information output designation signal outputted from the validity information counter 133 is also in the on state. Accordingly, the internal validity information clear and mask control circuit 132 keeps the states of the mask signal and the clear signal. As a result, validity information is appended to dt4, dt3, dt2, and dt1 outputted from the output terminals c1, c2, c3, and c4 respectively, and the ALU at the subsequent stage performs an operation process.

In this case, it is assumed that data inputted after dt4 is invalid. For example, it is assumed that if the validity information counter 133 detects input data to which validity information is not appended, then the validity information counter 133 resets the count and puts the validity information output designation signal into the off state. As a result, the internal validity information clear and mask control circuit 132 puts the mask signal and the clear signal into the high and low states respectively. Therefore, validity information is not appended to output data and the ALU at the subsequent stage does not perform an operation process. The validity information counter 133 keeps this state until four pieces of input data to each of which validity information is appended are inputted in succession.

Validity information appended to output data is handled in this way. As a result, validity information appended to output data can be made valid when and after data used for performing an operation is collected. By doing so, an unnecessary operation can be avoided at the subsequent stage and there is no need to discard an unnecessary operation result. Moreover, if input data to which validity information is not appended is inputted, output data becomes invalid. In this case, an operation by the ALU at the subsequent stage can be stopped until data to which validity information is appended is collected.

### (3) Example 3

In example 3, input data (valid data) to which validity information is appended and input data (invalid data) to which validity information is not appended are mingled in input data.

In this example, each time four pieces of data are inputted from the input terminal (a0), an operation process is performed. However, input data to which validity information is appended and input data to which validity information is not appended are mingled in input data. In this example, even when input data to which validity information is not appended is inputted, an operation is not stopped. That is to say, when four pieces of input data to each of which validity information is appended are collected, an operation is performed.

With the multi-output delay element according to the embodiment of the present invention, the validity information counter 133 counts the number of pieces of input data which are inputted and to each of which validity information is appended, and detects whether four pieces of input data are collected. The mask signal is handled according to a detection result so that when four pieces of input data are collected, an operation will be permitted. When input data to which validity information is not appended is inputted, a delay operation control circuit 134 stops the delay process by outputting operation stop signals 1 and 2 to a data delay section 110 and a validity information delay section 120 respectively.

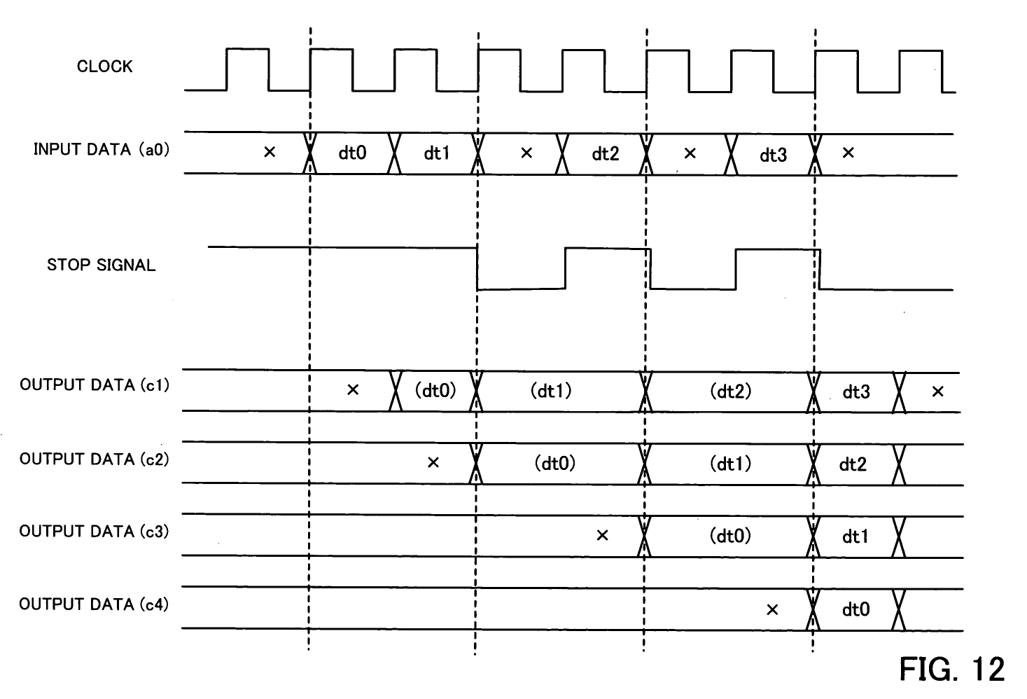

FIG. 12 is a time chart showing the operation of the multi-output delay element according to the embodiment of the present invention used in example 3.

Consecutive input data dt0, dt1, dt2, dt3, dt4, dt5, etc. inputted to the input terminal a0 of the multi-output delay element are delayed by each data delay element by one cycle and are outputted from the output terminals c1, c2, c3, and c4. Invalid data to which validity information is not appended is shown by “x”.

In this example, input data dt0 and dt1 to each of which validity information is appended are inputted to the input terminal a0 and invalid data is then inputted. After that, dt2, invalid data, and dt3 are inputted in that order.

The validity information counter 133 counts the number of pieces of input data to each of which validity information is appended. When the count of the validity information counter 133 reaches a designated number (four), the validity information output designation signal goes into the on state. Accordingly, until dt3 is inputted, the validity information output designation signal is in the off state and the mask signal and the clear signal outputted is in the low and high states respectively. During this time, validity information is not appended to data outputted from the output terminals c1, c2, c3, and c4, and the ALU at the subsequent stage does not perform an operation process.

When invalid data to which validity information is not appended is detected in the input data, the delay operation control circuit 134 stops the operation of the data delay section 110 and the validity information delay section 120 by putting the operation stop signals 1 and 2 (hereinafter referred to as the “stop signal” in block) into the low state. When the stop signal goes into the low state, the data delay section 110 and the validity information delay section 120 stop. When the stop signal goes into the high state, the data delay section 110 and the validity information delay section 120 operate. While the stop signal is in the low state, the data delay section 110 stops and output data is held. When the stop signal goes into the high state, the data delay section 110 resumes its operation and delays input data by one cycle. Accordingly, only when input data to which validity information is appended is inputted, the data delay section 110 performs delay operation. When four pieces of valid data are collected, they are outputted to the ALU at the subsequent stage. The validity information delay section 120 operates the same as the data delay section 110.

As stated above, if valid data and invalid data are mingled in input, it is possible to select only the valid data, to adjust timing at which the valid data is outputted, and to output the valid data to the ALU at the subsequent stage.

As has been described in the foregoing, the multi-output delay element according to the embodiment of the present invention provides a degree of freedom which is applicable to various operation processes. The number of delay elements, logical operation elements used for performing logical operations regarding a validity information process, and the like can be reduced. In addition, a user can easily build an arbitrary application.

The above three examples are simple examples of the embodiment of the present invention and many other examples can be imagined.

Each of the delay circuit according to the present invention and a processor including this delay circuit includes the data delay section including a plurality of data delay elements for delaying input data by predetermined delay amounts and the validity information delay section including a plurality of validity information delay elements for delaying validity information appended to the input data according to the delay amount of the input data, delays the input data and the validity information appended to the input data by desired delay amounts, and outputs the input data and the validity information appended to the input data. Therefore, when one piece of input data and validity information appended thereto are inputted to the delay circuit, plural pieces of output data and plural pieces of output validity information having different delay amounts can be obtained. As a result, the number of delay circuits which have traditionally been located according to output signal can be reduced.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A delay circuit for delaying and outputting an input signal on the basis of configuration information set in advance, the circuit comprising:
a data delay section including a plurality of data delay elements for delaying output of input data on the basis of predetermined delay amounts individually set at the time of receiving the input data; and
a validity information delay section including a plurality of validity information delay elements for delaying output of validity information appended to the input data in the case of the input data being valid according to the corresponding input data at the time of receiving the validity information.

2. The delay circuit according to claim 1, wherein:
in the data delay section, a data delay element train is formed by arranging the plurality of data delay elements on a path along which the input data is transmitted, and the input data is transmitted in order in accordance with order of the plurality of data delay elements in the data delay element train; and
in the validity information delay section, a validity information delay element train is formed by arranging the plurality of validity information delay elements on a path along which the validity information is transmitted, and the validity information is transmitted in order in accordance with order of the plurality of validity information delay elements in the validity information delay element train.

3. The delay circuit according to claim 1, wherein:
the data delay section includes an output dedicated register between each of the plurality of data delay elements and each external output terminal; and
output data from each of the plurality of data delay elements is outputted to the outside via the output dedicated register.

4. The delay circuit according to claim 1, further comprising a delay control section for controlling operation of the data delay section and the validity information delay section on the basis of a control signal including operation designation based on the configuration information at the time of receiving the control signal.

5. The delay circuit according to claim 4, wherein when the delay control section receives instructions to stop operation as the control signal, the delay control section controls the executing and stopping of the operation of the data delay section and the validity information delay section in response to the control signal.

6. The delay circuit according to claim 4, wherein:
the delay control section detects a state of the validity information appended to the input data inputted to the data delay section in response to the operation designation based on the configuration information; and
only if the input data is valid, the delay control section causes the data delay section to operate.

7. The delay circuit according to claim 4, wherein:
the delay control section includes a counting section for counting the number of the input data to which the validity information is appended in response to the operation designation based on the configuration information; and
the delay control section controls a state of output validity information outputted from the validity information delay section according to a count of the counting section.

8. The delay circuit according to claim 7, wherein until the count of the counting section reaches a designated number based on the operation designation, in accordance with the operation designation the delay control section gives the validity information delay section instructions to keep the output validity information outputted by the validity information delay section in an invalid state.

9. The delay circuit according to claim 7, wherein:
until the count of the counting section reaches a designated number based on the operation designation, in accordance with the operation designation the delay control section gives the validity information delay section instructions to keep the output validity information outputted by the validity information delay section in an invalid state; and
when the count of the counting section reaches the designated number, the delay control section gives the validity information delay section instructions to put the output validity information outputted by the validity information delay section into a valid state, and initializes the counting section.

10. A processor for performing predetermined operation processes while switching connection of modules for delaying an input signal and performing the predetermined operation processes on the basis of configuration information set in advance, the processor comprising:
a delay module including:
a data delay section including a plurality of data delay elements for delaying output of input data on the basis of predetermined delay amounts individually set at the time of receiving the input data, and
a validity information delay section including a plurality of validity information delay elements for delaying output of validity information appended to the input data in the case of the input data being valid according to the corresponding input data at the time of receiving the validity information; and
an operation processing module for inputting output data and the validity information outputted from the delay module and for performing the predetermined operation processes on the basis of the configuration information.
